(19) United States
(12) Patent Application Publication
(10) Pub. No.: US 2020/0176957 A1
(43) Pub. Date: Jun. 4, 2020

(54) VEHICLE TREATMENT FACILITY WITH PULL-OUT SYSTEM

(71) Applicant: WashTec Holding GmbH, Augsburg (DE)

(72) Inventors: JÜRGEN ANKNER, Friedberg (DE); RONALD FISCHER, Augsburg (DE); MICHAEL BRAUNBARTH, Kaufering (DE); ULRICH KÖLBL, Friedberg (DE)

(21) Appl. No.: 16/623,081

(22) PCT Filed: Jun. 14, 2018
(86) PCT No.: PCT/EP2018/065824

§ 371 Date: Dec. 16, 2019

(30) Foreign Application Priority Data
Jun. 16, 2017 (DE) 10 2017 113 262.7

(51) Int. Cl. H02B 1/36; B60S 3/04

(52) U.S. Cl. CPC H02B 1/36; B60S 3/04

(57) ABSTRACT

A vehicle treatment facility, in particular a gantry washing facility, includes at least one outer body formed as a vertical pillar and in which at least one operating unit is housed or can be housed. The outer body includes at least one pull-out, by which the at least one operating unit is movable in translation between a closed position, in which the operating unit is housed in the outer body, and an opened position, in which the operating unit is at least partially accessible from outside.

### CROSS REFERENCE TO RELATED APPLICATIONS

This application is the United States national phase entry of International Application No. PCT/EP2018/065824, filed Jun. 14, 2018, which claims the benefit of priority of German Application No. 10 2017 113 262.7, filed Jun. 16, 2017. The contents of International Application No. PCT/EP2018/065824 and German Application No. 10 2017 113 262.7 are incorporated by reference herein in their entireties.

### FIELD

The present invention relates to a vehicle treatment facility, in particular a gantry washing facility, with at least one outer body, in particular a vertical pillar of a washing gantry, in which at least one operating unit (e.g. a control element, a media container, an electronic, pneumatic, hydraulic component or the like) is housed or can be housed.

### BACKGROUND

In vehicle treatment facilities, in particular in gantry washing facilities, various units required for the operation of the facility (operating units), such as control elements, media containers, electronic, pneumatic, hydraulic components and the like, are stored in housings or outer bodies. For example, in a gantry washing facility, the media containers are usually located in one vertical pillar of the washing gantry, while the electronics are located in the other vertical pillar of the washing gantry. The operating units described above are accessible via swing doors on the pillar front of the gantry washing facilities known in the prior art, not only to mount the respective parts for the first time, but also for allowing maintenance during operation. For example, the canisters containing the washing chemicals have to be refilled or defective/outdated electronic components have to be replaced.

Usually, the operating units are all arranged in the width direction of the gantry and face the gantry front. Since the width of the halls is usually given (e.g. four meters) and modern vehicles (e.g. SUVs) are increasing in size and width, the pillar width and the space available for the aforementioned elements is limited. Furthermore, it would be desirable if the clear width between the pillars could be increased while maintaining the same external dimensions. However, a further limitation is that a drying fan is provided on the respective inner sides of the gantry pillars, which reduces the available space within the pillars.

The aforementioned, conventional configuration of the operating units in the pillars of a washing gantry therefore has the disadvantage that the installation space available in the pillar cannot be used optimally, or that when the installation space is used, the operating units positioned at the rear, as seen from the swing door, are difficult to access.

### SUMMARY

It is therefore the object of the present invention to provide means and ways to improve accessibility of operating units within outer bodies in vehicle treatment facilities.

A vehicle treatment facility of the gantry washing facility type according to the invention basically has at least one washing gantry. At least one (vertical) pillar of the washing gantry has an outer body or housing in which at least one operating unit, in particular a control element and/or a media container and/or an electronic, pneumatic or hydraulic component, is housed or can be housed. According to the inventive solution, this outer body has at least one pull-out means by which the at least one operating unit can be moved translatorically between a closed position, in which the operating unit is housed in the outer body/housing, and an opened position, in which the operating unit is at least partially accessible from the outside, i.e. in the closed position the at least one operating unit is arranged in a pillar of the washing gantry and can be pulled out of it by means of the pull-out means in order to be accessible from the outside.

In other words, an operating unit, i.e. a unit used to operate the facility, such as a control element and/or a media container and/or an electronic, pneumatic or hydraulic component, is arranged in a normal state (the closed position) inside an outer body or housing and thus shielded from external influences. For initial installation, maintenance, replacement, refilling or a similar operation, said operating unit can be pulled out of the outer body/housing via a pull-out means. For this purpose, the at least one operating unit is mounted on the outer body/housing so as to be relatively displaceable either directly or indirectly via the pull-out means. The outer body/the housing will necessarily have an access door/opening, in particular a lockable one, through which the at least one operating unit can be pulled out of the outer body/the housing by means of the pull-out means. In comparison to the solutions known in the prior art, operating units can be pulled out of the outer body/housing by such a pull-out system, so that operating units located at the rear as seen from an access door/opening can be easily reached.

According to a preferred aspect, the outer body may have at least one inner body can be housed within the outer body, in or at which the at least one operating unit is arranged or can be arranged. In such an exemplary configuration, the inner body is preferably mounted in the outer body via the pull-out means in such a way that the inner body is translatorically movable relative to the outer body between the closed position, in which the inner body is housed in the outer body, and the opened position, in which the operating unit arranged in the inner body is at least partially accessible from the outside. This means that the outer body or the gantry pillar can have one or more inner bodies, which can be moved between the opened position and the closed position. At each inner body, one or more operating units such as media containers, electronic components etc. can be arranged, which are then accessible from the outside in the opened position of the respective inner body. Advantageously, the at least one inner body can be designed with prefabricated fastening devices, such as plug connections or drill holes, which allow easy installation and/or deinstallation of the operating units on the inner body. In accordance with a particularly preferred exemplary configuration, plug-in or snap-in connections can be provided on the inner body, which enable tool-free snap-in of operating units with corresponding complementary designs.

According to a preferred aspect, the inner body can have essentially the same length dimension as the interior of the outer body or the pillar in order to make use of the entire available space.

According to a preferred exemplary configuration, the vehicle treatment facility can have a direction of passage in which a vehicle to be treated passes through it, and the outer body or the pillar can be essentially cuboid and can have a greater edge length in the direction of passage than transverse to it. In a corresponding exemplary configuration, for example, a vertical pillar of a washing gantry according to the invention can have a longer side length in the longitudinal gantry direction than in the transverse gantry direction (transverse to the direction of passage). Such a construction of the pillars narrowed in the gantry width direction has the advantage that the clear width of the vehicle treatment facility can be increased without increasing the outer dimensions of the gantry. Due to the pull-out system according to the invention, good accessibility of the at least one operating unit arranged in the pillars is nevertheless provided.

According to another preferred aspect of the invention, the operating unit and/or the inner body can be moved translatorically between the closed position and the opened position by means of the pull-out means essentially parallel to the direction of passage, in particular reverse to the direction of passage. Preferably, a linear movement can be carried out by means of the pull-out means. In other words, the operating units can preferably be pulled out linearly from a front side of the pillar(s) by means of the pull-out means (and possibly indirectly via the inner body).

According to another preferred embodiment, the operating unit may be exposed and/or accessible in the opened position of the inner body in the direction transverse to the direction of passage. For this purpose, all pull-out means can be arranged on the same inner surface of the outer body/of the pillar. Further preferably, the at least one inner body can be mounted with its rear side on the pull-out means arranged in this way and form a kind of rear wall, so that the at least one operating unit is accessible from the side opposite the rear wall of the inner body (or the pull-out means). Especially preferred, the at least one operating unit can be accessible in the opened position from the inner gantry side. In other words, preferably a pull-out system similar to a pharmacist's cupboard can be provided, so that the at least one operating unit (if applicable with the inner body) can be pulled out by means of the pull-out means in the direction of passage of the gantry and is accessible/reachable in the opened position transversely to the direction of passage.

According to another preferred aspect of the invention, at least the inner body can have a front panel on a short front side that closes with the outer body or shuts the access opening in the closed position, especially in a flush manner, and especially preferred in media-tight manner. In this way, shielding of the operating units arranged in the outer body/in the pillar against external influences can be ensured. According to an alternative exemplary configuration, the access opening can also be closed with a swing or sliding door.

According to another preferred exemplary configuration, the outer body can have a number of inner bodies, each of which can be moved separately between the closed position and the opened position via its own pull-out means, and in each of which at least one operating unit is arranged or can be arranged. Preferably, this can involve several inner bodies arranged vertically on top of each other, each of which is separately guided linearly via its own pull-out means and further preferably all of which can be accessed/reached from the same side in the opened position.

According to a further preferred aspect of the invention, the pull-out means can be designed as a rail, in particular as a telescopic rail. Preferably, the telescopic rail can be supported by a ball bearing guide in order to be able to carry even heavy loads.

According to a further preferred exemplary configuration, the vehicle treatment facility can have a moving unit, in particular a servomotor or pneumatics, for the power-operated movement of the inner body relative to the outer body.

According to a further, preferred aspect of the invention, the vehicle treatment facility may comprise a latching device for releasable latching of the inner body and/or the pull-out means (relative to the outer body/pillar) in the closed position and/or in the opened position. Such a latching device is particularly important if the pull-out direction is parallel to the direction of passage in order to prevent unintentional movement or opening of the pull-out means/inner bodies/operating units due to movement of the vehicle treatment device (washing gantry).

According to a further, preferred exemplary configuration, the vehicle treatment facility may have a safety device. In such an exemplary configuration, the safety device is designed to detect when at least one operating means or the inner body is not in the closed position and prevents the vehicle treatment facility from operating if it detects that the operating means or the inner body is not in the closed position. Preferably, the safety device can be a contact breaker, which can be arranged e.g. on the inner body or the pull-out means or the front panel.

### BRIEF DESCRIPTION OF THE DRAWING FIGURES

The invention is explained in more detail below using preferred embodiments with reference to the accompanying figures. The figures are merely schematic in nature and serve exclusively to understand the invention. The same elements are provided with the same reference signs.

The figures show:

FIG. 1 shows a perspective view of a vehicle treatment facility according to a preferred exemplary configuration with extended media containers;

FIG. 2 shows a detailed view of a pull-out means for media containers according to the preferred exemplary configuration;

FIG. 3 shows a detailed view of a pull-out system for media containers according to the preferred exemplary configuration;

FIG. 4 shows a rear view of the pull-out system for media containers according to the preferred exemplary configuration;

FIG. 5 shows a perspective view of the vehicle treatment facility according to the preferred exemplary configuration with extracted electronic components;

FIG. 6 shows a detailed view of a pull-out means for electronic components according to the preferred exemplary configuration;

FIG. 7 shows a detailed view of a pull-out system for electronic components according to the preferred exemplary configuration; and

FIG. 8 shows a rear view of the pull-out system for electronic components according to the preferred exemplary configuration.

### DETAILED DESCRIPTION

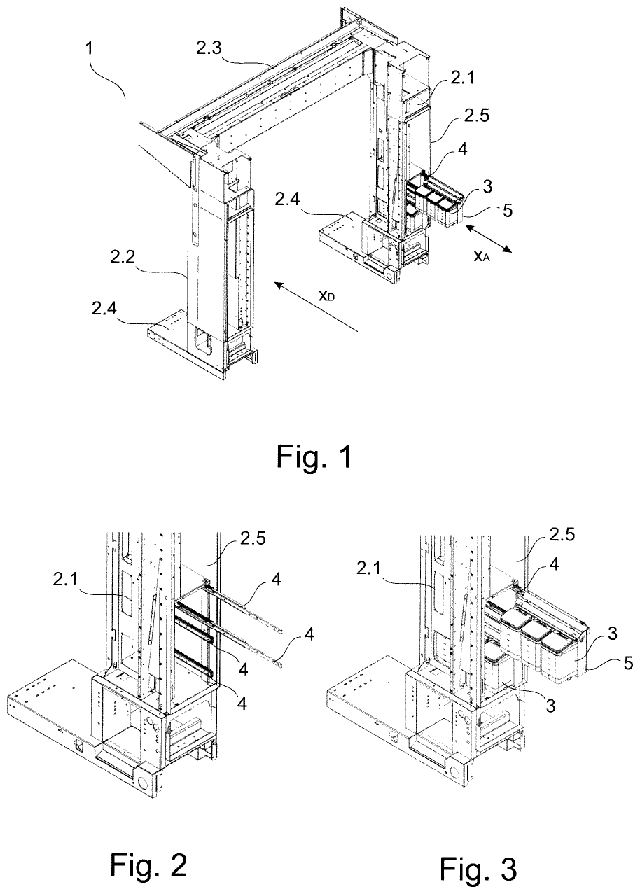

FIG. 1 shows a perspective view of the interior of a vehicle treatment facility 1, more precisely of a gantry washing facility, according to a preferred exemplary configuration of the invention. In its basic configuration, the vehicle treatment facility 1 has two vertical (gantry) pillars 2.1, 2.2 and a crossbeam 2.3 connecting the two pillars, on which various vehicle treatment devices, such as rotating brushes or nozzles, are usually arranged. At the lower end of each pillar 2.1, 2.2 there is a gantry base 2.4 by means of which the vehicle treatment facility can be moved linearly, e.g. via a rail system. The figure shows the load-bearing (metal) body of the gantry, without cladding and without the aforementioned vehicle treatment devices, within which various installations/units/components 3 (hereinafter referred to as operating units 3) used or necessary for the operation of the vehicle treatment facility 1 are or can be arranged. Examples of operating units 3 that are arranged or can be arranged inside the body of the gantry are control elements, media containers, electronic, pneumatic, hydraulic components and the like. The arrangement of the operating units 3 within the gantry body provides on the one hand protection for the operating units 3 and on the other hand ensures short distances to the devices supplied/controlled by the operating units, e.g. the vehicle treatment devices (not shown) arranged on the gantry 2.1, 2.2, 2.3.

The two vertical pillars 2.1, 2.2 form a clear width in which a vehicle to be treated (not shown) can be parked to be treated by the vehicle treatment devices (not shown) arranged at the vehicle treatment facility 1. Accordingly, the vehicle treatment facility 1 has a direction of passage x_{D} in which the vehicles to be treated pass through the vehicle treatment facility 1. In the following, the direction of passage x_{D} is defined as the longitudinal direction of the vehicle treatment facility 1 and the direction transverse to it as the width direction of the vehicle treatment facility 1.

It is a long-standing need in the respective expert groups to increase the clear width between the pillars 2.1, 2.2 while maintaining the same outer dimensions of the gantry 2.1, 2.2, 2.3. This has the background that (modern) vehicles tend to become wider rather than narrower, while the width (often approx. 4 m) of the halls already built for vehicle treatment facilities is fixed. At the same time, it is difficult to reduce the width of the vertical pillars 2.1, 2.2 without impairing the accessibility of the operating units 3 arranged therein.

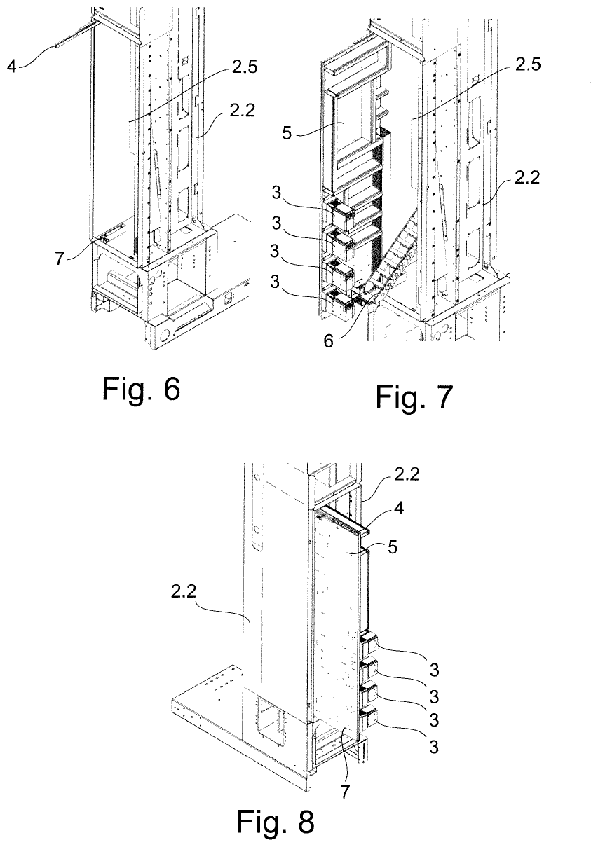

In order to solve this problem, the gantry washing facility 1 shown has a pull-out system with several (linear) pull-out means 4 (cf. FIGS. 2 and 6), on which a number of operating units 3 (media containers) are stored via an inner body 5 to be extendable in a pull-out direction x_{A}. In this way, the interior of the pillars 2.1, 2.2 can be pulled out of a closed position, in which the operating units 3 are housed in the pillars 2.1, 2.2, into an opened position, in which even the rearmost operating units 3 are easily accessible.

According to the exemplary configuration shown, the pull-out direction x_{A} is parallel to the direction of passage x_{D}. The pull-out system is arranged in such a way that pulling out of a corresponding access opening 2.5 takes place in the front of the vertical pillars 2.1, 2.2. The arrangement of the access opening 2.5 in the front of the pillars 2.1, 2.2 and thus in the short sides of the pillars 2.1,2.2 is on the one hand advantageous for the statics of the vehicle treatment facility 1 or of the gantry body and on the other hand the access opening 2.5 is turned away from the treatment media sprayed during the vehicle treatment. In addition, the rotating vertical brushes (not shown) of the vehicle treatment facility 1 are arranged on the rear sides of the vertical pillars 2.1, 2.2, so that positioning the access opening 2.5 or the pull-out system 3, 4, 5 on this side would not be practicable.

The pull-out means 4 are arranged in the shown embodiment on the inner walls of the vertical pillars 2.1, 2.2 facing the outside of the vehicle treatment facility 1. The operating units 3 are each detachably attached with their rear sides to the inner bodies 5, which are in turn attached with their rear sides to the pull-out means 4 (cf. FIGS. 3 and 7). The pull-out system 3, 4, 5 designed with this construction can be pulled out parallel to (or reverse to) the direction of passage x_{D} and, in the pulled-out state (in the opened position), is accessible in the direction transverse to the direction of passage x_{D}. More precisely, the operating units 3 are accessible from the inside (i.e. from the passageway) in the opened position and can be, for example, filled or exchanged from there. The aforementioned arrangement makes it possible to use the entire interior of the pillars 2.1, 2.2 in the longitudinal direction, even with the comparatively narrow construction of the pillars 2.1, 2.2, and still be able to comfortably reach the operating units 3. In comparison, the gantry washing facilities known in the prior art have a partition sheet parallel to the access opening 2.5 (or transverse to the direction of passage) on which all installations/operating units 3 are mounted, which is why the depth dimension (in the longitudinal direction) of the pillar is not used efficiently and why the pillar width cannot be further reduced in these known facilities. It could therefore be said that in the shown installation space concept according to the invention, this partition sheet was omitted, the installations/operating units 3 were rotated by 90° and mounted on a pull-out system.

In the vehicle treatment facility 1 shown, various media containers 3 are arranged in one of the vertical pillars 2.1, in which (chemical) treatment media are stored, which can be applied to a vehicle either undiluted or mixed with water from a water source during vehicle treatment by means of vehicle treatment devices (nozzles) that are not shown. The media containers 3 are mounted in several inner bodies 5 arranged vertically on top of each other, which can each be pulled out of the vertical pillar 2.1 using two pull-out means 4. Each inner body 5 essentially uses the entire length dimension of the outer body 2.1 formed by the gantry pillar 2.1, thus enabling optimum use of space. The multi-unit system shown here with several inner bodies 5 arranged vertically on top of each other that can be pulled out separately has the advantage that the media containers 3 that are pulled out separately are always accessible from above and can therefore be filled easily.

In the opposite (left) vertical pillar 2.2 of the vehicle treatment facility 1 shown, various electronic components 3 are arranged at an inner body 5 (see FIGS. 5 to 8). In contrast to the separately extendable, inner bodies of the pillar 2.1 arranged vertically on top of each other, the electronic components 3 of the pillar 2.2 are mounted on a common mounting plate 5, which forms the inner body 5. The electronic components 3 can therefore be pulled out as one unit from the inside of the outer body formed by the vertical pillar 2.2. to be accessible for maintenance or replacement work. The mounting plate 5 can advantageously have retaining structures, slots and/or mounting holes that allow easy assembly of standardized electronic components 3. The inner body 5 or the mounting plate can also have integrated electronic structures/conductor structures for the power supply or for communication between the electronic components 3.

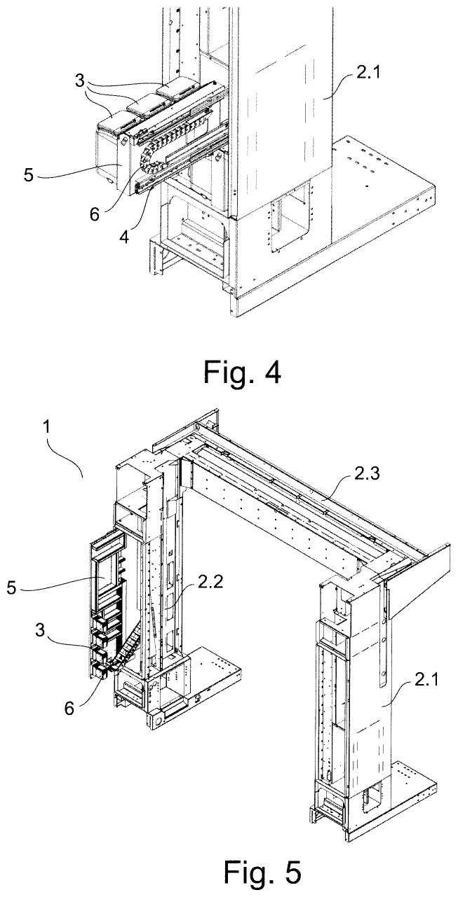

The pull-out means 4 or the inner body 5 are power-operated to be movable according to the preferred exemplary configuration by a moving unit which is not shown, e.g. by a servomotor or a pneumatic unit, relative to the outer body 2.1, 2.2, so that the user is supported in moving the often heavy operating units 3. As is best seen in FIGS. 4 and 7, an energy chain 6 can be advantageously provided on the inner body 5 to ensure compliance with the smallest permissible bending radius of hoses and/or cables carried on the inner body 5.

The pull-out means 4 in the preferred exemplary configuration shown here are designed as telescopic rails, which provide a long extension path with comparatively high stability. In the example shown, the rails of the telescopic rails that can be moved relative to each other are designed as heavy-duty pull-outs and are supported by a ball guide.

It is advantageous if front panels (not shown) are arranged on the front sides of the inner bodies 5 or the pull-out means 4, which close the access opening 2.5 in the closed position of the pull-out means 4, preferably in a media-tight manner. Alternatively, it is also conceivable that the access opening can be closed by a swing door (not shown), which, after opening, allows the inner bodies 5 with the operating units 3 to be pulled out via the pull-out means.

As is best seen in FIGS. 6 and 8, the shown vehicle treatment device 1 has a latching device 7, here exemplarily realized by a spring preloaded bolt 7 with matching bores 7 in the inner body 5, by which detachable latching of the inner body 5 (or alternatively of the pull-out means 4) is possible in the closed position and/or in the opened position. In this way, unintentional movement of the inner body 5 as a result of movement of the vehicle treatment device 1 during operation can be prevented.

A further advantageous feature of the shown vehicle treatment facility 1 is a safety device which is designed to detect when an inner body 5 or a pull-out means 4 is not in the closed position and in such a case to prevent operation of the vehicle treatment facility for safety reasons. In the example shown, this is implemented by contact breakers (not shown) on the front panels of the inner bodies 5, which detect if the front panels are not closed/flush with respect to the outer body formed by the vertical pillar 2.1, 2.2.

1. A gantry washing facility comprising:
at least one outer body designed as a vertical pillar of a washing gantry, in which at least one operating unit is housed,
the at least one outer body comprising at least one pull-out by which the at least one operating unit is translatorically movable between a closed position in which the at least one operating unit is housed in the at least one outer body and an opened position in which the at least one operating unit is at least partially accessible from the outside.

2. The gantry washing facility according to claim 1, wherein the at least one outer body has at least one inner body which can be housed inside the at least one outer body, in or at which the at least one operating unit is arranged or can be arranged; and in that the at least one inner body is supported in the at least one outer body via the pull-out in such a way that the at least one inner body is translatorically movable relative to the at least one outer body between the closed position in which the at least one inner body is housed in the at least one outer body and the opened position in which the at least one operating unit arranged in or at the at least one inner body is at least partially accessible from the outside.

3. The gantry washing facility according to claim 1, wherein the gantry washing facility has a direction of passage in which a vehicle to be treated passes through it, and the at least one outer body is substantially cuboid in shape and has a greater edge length in the direction of passage than in the transverse direction theretoa direction transverse to the direction of passage.

4. The gantry washing facility according to claim 1, wherein the at least one operating unit and/or the at least one inner body can be moved by the at least one pull-out essentially parallel to the direction of passage in a translatory manner between the closed position and the opened position.

5. The gantry washing facility according to claim 1, wherein the at least one operating unit is exposed and/or accessible in the opened position of the at least one inner body in the direction transverse to the direction of passage.

6. The gantry washing facility according to claim 2, wherein the at least one inner body comprises a plurality of inner bodies and the at least one pull-out comprises a plurality of pull-outs, wherein each inner body is separately movable via its respective pull-out between the closed position and the opened position, and
wherein the at least one operating unit comprises a plurality of operating units, each of the plurality of operating units arranged in one of the plurality of inner bodies.

7. The gantry washing facility according to claim 1, wherein the at least one pull-out is designed as a rail which is supported via a ball guide.

8. The gantry washing facility according to claim 1, further comprising a moving unit for power-operated movement of the at least one pull-out and/or of the at least one inner body relative to the at least one outer body.

9. The gantry washing facility according to claim 1, further comprising a latching device for releasably latching the at least one inner body and/or the at least one pull-out in the closed position and/or in the opened position.

10. The gantry washing facility according to claim 1, further comprising a safety device designed to detect if the at least one inner body is not in the closed position, and which prevents operation of the gantry washing facility when it detects that the at least one inner body is not in the closed position.
